(19) United States
(12) Patent Application Publication
(10) Pub. No.: US 2026/0140842 A1
(43) Pub. Date: May 21, 2026

(54) Self-Improving Node Placer

(71) Applicant: CAST AI Group, Inc., Miami, FL (US)

(72) Inventors: Saulius Mašnauskas, Vilnius (LT); Valdas Rakutis, Vilnius (LT); Jan Sykora, Prague (CZ); Ivaylo Papratilov, Sofia (BG)

(21) Appl. No.: 19/094,518

(22) Filed: Mar. 28, 2025

Related U.S. Application Data
(60) Provisional application No. 63/722,197, filed on Nov. 19, 2024.

(51) Int. Cl. G06F 11/34

(52) U.S. Cl. CPC G06F 11/3433; G06F 11/3452

(57) ABSTRACT

A method for optimizing workload placement in a cloud computing environment includes collecting a sequence of snapshots of states of a plurality of workloads running on a plurality of compute instances. Based on the collected snapshots, a plurality of workload placement algorithms are determined, each applying a first sorting criterion for workloads and a second sorting criterion for compute instances. Each workload placement algorithm is applied to the snapshots to determine performance metrics associated with workload distribution and compute resource utilization. A workload placement algorithm is selected based on the performance metrics and applied to the cloud environment, causing at least one workload to be migrated from a first compute instance to a second compute instance.

### CROSS-REFERENCE TO RELATED APPLICATIONS

This application claims the benefit of U.S. Provisional Application No. 63/722,197, filed Nov. 19, 2024, which is incorporated by reference in its entirety.

### TECHNICAL FIELD

This disclosure relates generally to cloud computing, and more specifically self-improving placement of workloads on nodes.

### BACKGROUND

In cloud computing environments, such as Kubernetes clusters, traditional node placement strategies rely on predefined heuristics and rule-based strategies to determine when and how to scale clusters. However, these methods often fail to select the most resource-efficient nodes, leading to wasted cloud resources and higher operational expenses. Because each cluster has unique workloads and constrains, a static, one-size-fits-all approach results in inefficiencies, one-size-fits-all approach results in inefficiencies. These inefficiencies arise because such a traditional system lacks real-time optimization based on workload patterns and fails to consider dynamic factors such as fluctuating resource demands, cloud instance availability and variations. As a result, the system does not adapt dynamically to changing demands or evolving infrastructure conditions, leading to suboptimal performance and increased resource consumption to handle peak demand.

Further, Kubernetes clusters vary significantly in workload characteristics, topology constraints, and scaling patterns. Some clusters run homogenous workloads with thousands of identical pods, while others use complex topology constraints with strict placement requirements. Existing autoscaling approaches do not account for these differences, leading to suboptimal resource allocation. Without a way to tailor node placement strategies to the specific needs of each cluster, an autoscaler may deploy nodes inefficiently, resulting in higher resource consumption or reduced performance.

### SUMMARY

The present disclosure relates to a method for optimizing workload placement in a cloud computing environment by dynamically evaluating multiple workload placement algorithms. The method includes periodically collecting snapshots of the states of a plurality of workloads running on a plurality of compute instances. These snapshots capture resource utilization, workload distribution, and system constraints, serving as a basis for generating and evaluating multiple workload placement algorithms.

Based on these snapshots, several workload placement algorithms is generated, each employing a first sorting criterion for workloads and a second sorting criterion for compute instances. Each algorithm is tested by applying it to the collected snapshots, and performance metrics such as resource utilization efficiency, scheduling latency, and availability are determined. The system then selects the optimal workload placement algorithm based on these performance metrics and applies it to the cloud environment. As a result, at least one workload may be migrated from a first compute instance to a second compute instance. For example, the migration may involve moving a workload from a first compute instance with worse performance metrics (e.g., overutilized) to a second compute instance with better performance metrics (e.g., underutilized), thereby improving the efficiency and performance of workloads.

By continuously analyzing workload placement performance and adapting to real-time conditions, this method enables self-optimizing workload scheduling, reducing cloud infrastructure resource consumption while improving compute resource utilization.

### BRIEF DESCRIPTION OF THE DRAWINGS

FIG. 1 is a block diagram of a system environment in which an automation system may be implemented, in accordance with one or more embodiments.

FIG. 2 illustrates an example architecture of a node placer module, in accordance with one or more embodiments.

FIG. 3 is a table showing different bin packing algorithms generated by combining pod sorting algorithms and compute instance sorting algorithms, in accordance with one or more embodiments.

FIG. 4 illustrates an example code snippet that defines a list of pod sorting algorithms that represent different ways to sort pods, in accordance with one or more embodiments.

FIG. 5 illustrates an example code snippet that defines a list of instance sorting algorithms that represents different ways to sort compute instances, in accordance with one or more embodiments.

FIG. 6 illustrates an example code snippet that defines a hierarchical structure for managing bin packing algorithms, in accordance with one or more embodiments.

FIG. 7 illustrates an example code snippet configured to capture results of pod placement operations, in accordance with one or more embodiments.

FIG. 8 is a flowchart of a method for pod placement in a cloud computing environment, in accordance with one or more embodiments.

FIG. 9 is a block diagram of an example computer suitable for use in a networked computing environment in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

Cloud environments rely on autoscalers to provision new compute nodes (also referred to as compute instances) when workloads (or pods) require additional resources. While efforts have been made toward determining the most cost-effective and efficient placement of pods on these nodes (e.g., efforts toward solving the known “Bin Packing problem”), there is no known algorithm that can solve the node placement problem in polynomial time for all cases. Moreover, finding a best solution requires exponential time, making doing so impractical or infeasible for large inputs.

In Kubernetes autoscaling, nodes (cloud instances) correspond to bins, and pods (workloads) correspond to items that are placed into the bins (i.e., nodes). Each pod has CPU, memory, storage, and networking requirements. Each node also has finite resources and constraints. Placing too many pods on a node could overload the node, reducing its performance. Placing too few pods on a node would result in the node being underutilized, increasing a total number of nodes provisioned. Systems and methods are disclosed herein for efficiently allocating pods to nodes while minimizing a number of nodes provisioned and maintaining optimal performance.

The embodiments described herein introduce an automation system with a self-improving node placer that collects snapshots of pods running on nodes in a cloud environment, where the pods may or may not be optimally placed. The node placer dynamically groups pods and generates multiple bin packing algorithms for placing pods into nodes based on the snapshots. The node placer then evaluates these algorithms in the background to identify one or more bin packing algorithms that perform best. The autoscaler is configured to apply the identified optimal algorithms. Unlike conventional autoscaling methods that rely on fixed heuristics, this system dynamically assesses various bin packing and grouping algorithms, gathering performance metrics to refine future scaling decisions. By running multiple candidate algorithms on cluster snapshots, the system ensures that autoscaling decisions are guided by real-time data rather than static rules.

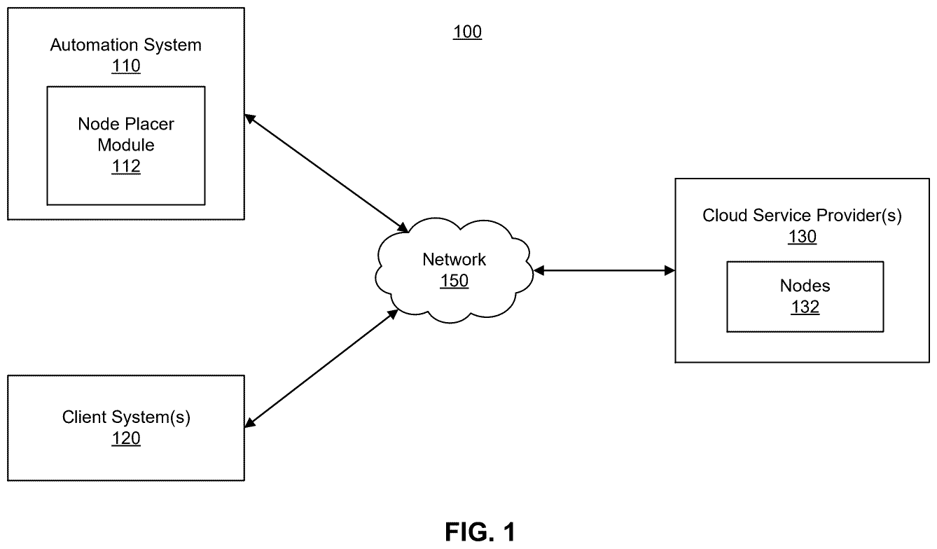

Additional details about the system are further described below with respect to FIGS. 1-8.

### System Architecture

FIG. 1 is a block diagram of a system environment 100 in which an automation system 110 (also referred to “the system”) may be implemented in accordance with one or more embodiments. The environment 100 includes the automation system 110, one or more client devices 120, and one or more cloud service provider(s) 130, interconnected via a network 150. The cloud service provider(s) 130 host one or more nodes 132, which may be virtual machines (VMs). The cloud service provider(s) 130 may include (but are not limited to) Amazone Web Services (AWS)®, Google Cloud Platform (GCP)®, and/or Microsoft Azure®. The cloud service provider 130 provides computing resources, such as VMs, storage, and networking, over the network 150. VMs are scalable, software-based representations of physical machines that can run operating systems and applications. Networking includes virtualized network components, such as firewalls, and virtual private networks (VPNs). These resources may be made available to users on-demand, enabling flexibility and scalability. In some embodiments, the nodes 132 are part of a Kubernetes cluster, which is a distributed system for managing containerized applications across multiple VMs. Additional details about clusters, Kubernetes services, and cloud service providers (CSPs) are described in U.S. patent application Ser. No. 17/380,729, filed Jul. 20, 2021 (now issued as U.S. Pat. No. 11,595,306), which is incorporated herein in its entirety.

The automation system 110 includes a node placer module 112 configured to determine which pods are to be placed into which nodes (or compute instances). As discussed above, the only way to find the most optimal output is to try all pod grouping permutations and check all available compute instances. However, that is impossible due to the factorial algorithmic complexity. To address this problem, the node placer module 112 implements a combination of grouping algorithms and bin packing algorithms, which enable the identification of a near-optimal solution in seconds to minutes. The node placer module 112 periodically collects snapshots of pods placed on nodes 132, and the grouping algorithms and bin packing algorithms are run on these snapshots.

The grouping algorithms are configured to group pods before they are assigned to nodes. The grouping algorithms may include (but are not limited to) a least groups algorithm. The least groups algorithm is configured to minimize the number of pod groups by maximizing compatibility between workloads before placement onto compute nodes. This approach works by evaluating which compute instances are viable for each pod and identifying intersections in viable instance sets. If two pods share at least one compatible compute instance, they are grouped together, thereby shrinking the set of potential compute resources required. If a pod does not share any pod placing algorithms instance with an existing group, it initiates a new group. The algorithm can iterate multiple times (e.g., up to a threshold number of times), randomizing pod order during each pass to explore different grouping possibilities to find a better grouping or terminating within a predefined limit.

In some embodiments, the grouping algorithms may also include an availability zone (AZ) constraint algorithm, incorporating AZ constraints to ensure workloads are optimally distributed across cloud infrastructure. An Availability Zone (AZ) is an isolated location within a Cloud Service Provider (CSP)'s region. Each AZ includes one or more data centers with independent power, cooling, and networking infrastructure. CSPs distribute their infrastructure across multiple AZs within a region, enabling applications to achieve high availability and disaster recovery by deploying resources across different AZs. However, data transfer between different AZs travels through specialized networking infrastructure maintained by CSPs, which consumes additional hardware resources. In some cases, it is advantageous to place software components that frequently communicate with each other in the same AZ to reduce hardware resource consumption. Here, the AZ constraint algorithm may specify whether a pod should be placed in one or more specific AZs. Pods that should be placed in the same AZ are placed in the same group. This algorithm may be applied in combination with the least groups algorithm to modify the groupings generated by the least groups algorithm.

The bin packing algorithms are generated dynamically. The bin packing algorithms include a combination of pod sorting algorithms and compute instance sorting algorithms. Pods can be sorted by a pod property or an attribute outside of the pod's resource. For example, pods can be sorted based on their total CPU requests, memory requests, CPU and memory request ratio, namespace, and name, among others. Compute instances can be sorted based on CPU capacity, memory capacity, price, availability, normalized CPU price, attachable volume limit, and GPU capacity, among others.

The bin packing algorithms are applied to each group of pods to place each pod in the group on a compute instance. Each bin packing algorithm combines a pod sorting algorithm and a compute instance sorting algorithm. For example, a bin packing algorithm may combine a pod sorting algorithm based on CPU and a compute instance sorting algorithm based on CPU. The pod sorting algorithm based on CPU sorts pods based on their CPU requests, from largest to smallest. The compute instance sorting algorithm based on CPU sorts compute instances based on total CPU capacity, from largest to smallest. For pods in the same group, the bin packing algorithm causes a pod corresponding to the largest CPU request to be placed in the compute instance corresponding to the largest CPU capacity. After the largest pod is placed in the largest compute instance, the second largest pod is placed in the largest compute instance if the largest compute instance has sufficient CPU resources left. Otherwise, the second largest pod is placed in the second largest compute instance. This process repeats until each pod is placed in a compute instance.

Further, multiple bin packing algorithms are generated based on the snapshots. Each bin packing algorithm combines a pod sorting algorithm and a compute instance sorting algorithm. The performance metrics of these bin packing algorithms are evaluated to identify the best-performing bin packing algorithm. Since these bin packing algorithms cannot be applied to live pod placements simultaneously, their performance metrics are instead determined based on snapshots collected from pods currently running on compute instances. The node placer module 112 periodically collects snapshots of each pod and compute instance, e.g., every 15 seconds. These snapshots include pod placements, resource utilization, and performance metrics at a given point in time. The node placer module 112 can apply these snapshots to multiple bin packing algorithms in a simulated environment to determine how each algorithm would perform if applied in real-time.

In some embodiments, the node placer module 112 selects a bin packing algorithm that has the best performance metrics and causes the autoscaler to apply the selected bin packing algorithm. For example, the autoscaler monitors pod scheduling events in a Kubernetes cluster. When a pod cannot be scheduled due to insufficient node resources, the autoscaler triggers a scale-up event to add new nodes. The autoscaler obtains the best bin packing algorithm and applies the bin packing algorithm to the unschedulable pod. Alternatively, in some embodiments, all the pods (including the unschedulable ones) are re-sorted based on the pod sorting algorithm associated with the bin packing algorithm, and all the compute instances (including the newly provisioned ones) are re-sorted based on the compute instance sorting algorithm associated with the bin packing algorithm. The pods are placed into the compute instances based on the bin packing algorithm.

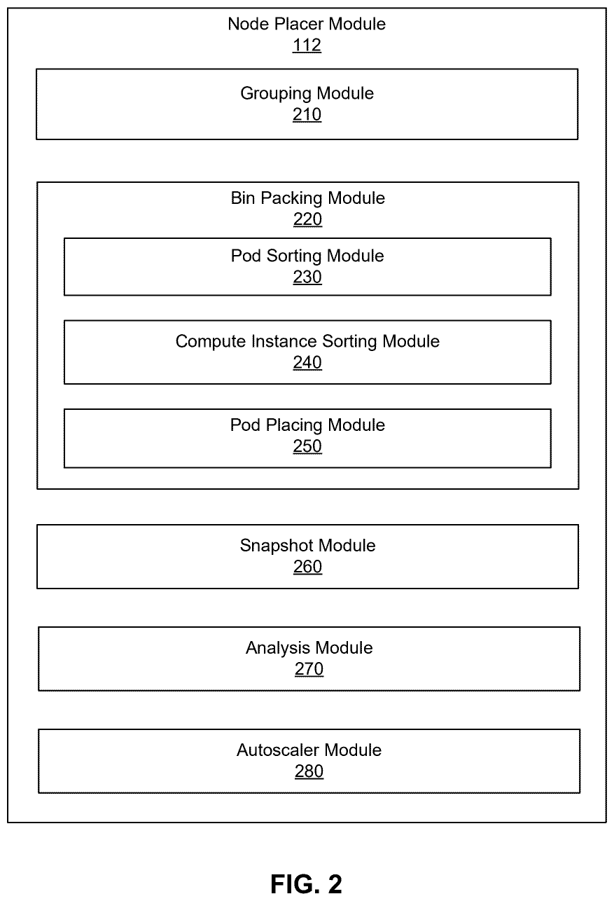

Additional details about the node placer module 112 and agents for determining network bandwidth metrics are further described below with respect to FIGS. 2-8.

The client device(s) 120 are computing systems associated with various entities. These entities include entities that can provision nodes 132 on the cloud service provider 130, as well as end-users who engage with applications deployed onto the nodes 132. The client devices 120 are also capable of receiving user input as well as transmitting and/or receiving data via the network 150. In one embodiment, a client device 120 is a computer system, such as a desktop or a laptop computer. Alternatively, a client device 120 may be a device having computer functionality, such as a personal digital assistant (PDA), a mobile telephone, a smartphone, or another suitable device. A client device 120 is configured to communicate via the network 150. In one embodiment, a client device 120 executes an application allowing a user of the client device 120 to interact with the automation system 110. For example, the client device 120 may execute a customer mobile application to enable interaction between the client device 120 and the automation system 110 or the cloud service providers 130. As another example, a client device 120 executes a browser application to enable interaction between the client device 120 and the system 110 via the network 150. In another embodiment, a client device 120 interacts with the system 110 through an application programming interface (API) running on a native operating system of the client device 120, such as IOS® or ANDROID™.

The network 150 is configured to facilitate communications among the automation system 110, client device 120, and cloud service provider 130. The network 150 may comprise any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

### Example Architecture of Node Placer Module

FIG. 2 illustrates an example architecture of a node placer module 112, in accordance with one or more embodiments. The node placer module 112 includes a grouping module 210, bin packing module 220, snapshot module 260, performance data analysis module 270, and an autoscaler module 280. In some embodiments, there may be additional or fewer modules than those illustrated in FIG. 2. Additionally, the functionalities of these modules may be redistributed, multiple modules may be combined into a single module, and/or a single module's functionalities may be divided into multiple modules.

The snapshot module 260 is configured to collect snapshots from the pods and compute instances periodically. In some embodiments, the snapshot module 260 implements a cron job (a scheduled background task) to aggregate performance metrics from pods and nodes. A cron job is a scheduled task that runs automatically at predefined time intervals. The snapshots may be collected by any combination of one or more of Kubernetes cluster APIs, cloud service provider APIs, autoscaler metrics, and the like. The Kubernetes cluster APIs include a pods API that provides all unschedulable pods with their resource requests and constraints, nodes API that provides existing nodes, their capacity, taints, and resource utilization, persistent volumes API that provides storage constraints relevant to scheduling, and scheduler information that determines which pods remain unschedulable and needs new nodes. The cloud service provider APIs can provide available instance types (such as EC2, GCP compute engine, Azure VM), instance pricing, regional and zonal availability, instance quotas and limits, among others. The autoscaler metrics may include data from the production autoscaler, such as recent scaling events (e.g., when and why new nodes were added).

In some embodiments, the snapshot module 260 executes a cron job, which queries Kubernetes APIs, cloud service provider APIs, and/or autoscaler periodically (e.g., every 15 seconds) to receive relevant and real-time data. The received data is structured and stored in a database as time series data.

The grouping module 210 is configured to group pods based on the data contained in the snapshots using various algorithms. In some embodiments, the various algorithms include a least groups grouping algorithm, which is configured to group pods into the minimum number of groups while ensuring compatibility between pods. Under the least groups grouping algorithm, the grouping module 210 evaluates attributes of each pod, such as resource requirements (CPU, memory, GPU, etc.), and identifies common compute instances across multiple pods. For example, if two or more pods share compatible resource requirements, they are considered compatible and placed in the same group. Pods with overlapping compatible resource requirements are grouped together to minimize the number of groups. If a pod has no shared resource requirements with any existing group, a new group is created. The grouping module 210 may randomize pod order and iterate the same process up to a threshold number of times (e.g., 10 iterations) or until a predetermined metric is achieved, such as a total number of groups falling below a specified threshold. Each iteration tries different pod combinations to find improved groupings.

Notably, a pod may be compatible with multiple compute instances. For example, as shown in Table 1 below, pod P1 may be compatible with compute instances A, B, and C; pod P2 may be compatible with compute instances B, C, and D; and pod P3 may be compatible with compute instances A, D, and E. Pods P1 and P2 share instances B and C, so they can be grouped into a first group, which shares compute instances B and C. Since pod P3 does not share instances B or C, pod P3 does not fit in the first group. As a result, a second group is initialized for pod P3, which shares instances A, D, and E. This generated grouping is shown in Table 2 below.

TABLE 1

| Pods | Compatible Compute Instances |
|---|---|
| P1 | A, B, C |
| P2 | B, C, D |
| P3 | A, D, E |

TABLE 2

| Groups | Pods | Shared Compute Instances |
|---|---|---|
| G1 | P1, P2 | B, C |
| G2 | P3 | A, D, E |

The grouping module 210 may randomize the order of pods P1, P2, and P3 and iterate the same process again to generate a new grouping. For example, after randomization, the grouping module 210 may generate a new order: P1, P3, and P2. Based on this order, P1 and P3 can be grouped into a single group that shares instance A. Since pod P2 does not share instance A, pod P2 will be placed in its own group. This generated grouping is shown below in Table 3.

TABLE 3

| Groups | Pods | Shared Compute Instances |
|---|---|---|
| G1 | P1, P3 | A |
| G2 | P2 | B, C, D |

Again, the grouping module 210 may further randomize the order of pods to P2, P3, and P1. Based on this order, P2 and P3 can be grouped into a single group that shares instance D. Since pod P1 does not share instance D, pod P1 will be placed in its own group. This generated grouping is shown in Table 4 below.

TABLE 4

| Groups | Pods | Shared Compute Instances |
|---|---|---|
| G1 | P2, P3 | D |
| G2 | P1 | A, B, C |

As such, multiple groupings are generated by randomly ordering the pods. In many cases, some of the groupings contain a fewer number of groups, while others contain a greater number of groups. The different groupings may be sorted based on their respective number of groups, and the grouping with the lowest number of groups may be selected as the final grouping of pods. If all groupings result in the same number of groups (as described in the example above), they may instead be sorted based on the average number of instances per group. The grouping with the highest or lowest average number of instances may be selected as the final grouping of pods. Alternatively, when all groupings result in the same number of groups, the grouping module 210 may randomly select one of the groupings as the output.

In some embodiments, the grouping module 210 may also apply an AZ constraint grouping algorithm configured to group pods based on their AZ constraints. Under the AZ constraint grouping algorithm, the grouping module 210 may further modify the groupings generated by the least groups grouping algorithm to ensure that pods are properly distributed in groups that meet AZ constraints. For example, as shown in Table 5 below, pod P1 is compatible with compute instances A, B, and C, and allowed to be in AZs of us-east-1a and us-east-1b; pod P2 is compatible with compute instances B, C, and D, and allowed to be in AZ of us-east-1a only; and pod P3 is compatible with compute instances A, D, and E, and allowed to be in AZs of us-east-1b and us-east-1c.

TABLE 5

| Pods | Compatible Compute Instances | Compatible AZs |
|---|---|---|
| P1 | A, B, C | us-east-1a, us-east-1b |
| P2 | B, C, D | us-east-1a |
| P3 | A, D, E | us-east-1b, us-east-1c |

The initial grouping by the least groups grouping algorithm may result in group G1 including pods P1 and P2 (which share Compute Instances B and C) and group G2 including pod P3 (which shares compute instances A, D, and E), as shown above in Table 2. The AZ constraint grouping algorithm is then applied to check AZ restrictions for each pod in group G1: Pod P1 can be in us-east-1a or us-east-1b, whereas pod P2 is restricted to us-east-1a only. Since P1 and P2 both share the AZ us-east-1a, G1 is now restricted to us-east-1a. If compute instances B and C in G1 are both in us-east-1a, they can both remain in G1; otherwise, any compute instance not in us-east-1a will be removed from G1. Assuming compute instance B is in us-east-1a and compute instance C is not, only compute instance B remains in G1. Another pod cannot be placed in group G1 unless it shares at least one instance with B in AZ us-east-1a. Similarly, G2's compute instances are restricted to us-east-1b and us-east-1c. Assuming compute instance A is in us-east-1b, compute instance E is in us-east-1c, and instance D is in a different AZ, only compute instances A and E will remain in Group G2. This updated grouping is shown in Table 6 below.

TABLE 6

| Groups | Pods | Shared Compute Instances | Shared AZs |
|---|---|---|---|
| G1 | P1, P2 | B, C | us-east-1a |
| G2 | P3 | A, E | us-east-1b, us-east-1c |

In addition to the least groups grouping algorithm and AZ constraint grouping algorithm, other grouping algorithms may also be implemented to group pods. For example, an availability-based grouping module may group certain pods into spot instances; a network affinity grouping module may group pods that frequently communicate with each other into a same group or AZ. These different grouping methods combined together can provide greater efficiency, allowing the node placer module 112 to dynamically select the most suitable grouping strategy based on real-time workload and infrastructure constraints.

For each group of pods, the bin packing module 220 is configured to pack pods into compute instances. The bin packing module 220 includes a pod sorting module 230, a compute instance sorting module 240, and a pod placing module 250. The pod sorting module 230 is configured to sort pods based on their attributes into a specific order. These attributes may be obtained from the snapshots collected by the snapshot module 260.

For example, in some embodiments, the pod sorting module 230 is configured to sort pods by total CPU requests from largest to smallest. In some embodiments, the pod sorting module 230 is configured to sort pods by total memory from largest to smallest. In some embodiments, the pod sorting module 230 is configured to sort pods by the requested CPU-to-memory ratio from smallest to largest.

Similarly, the compute instance sorting module 240 is configured to sort compute instances based on their attributes in a specific order. These attributes may also be obtained form the snapshots collected by the snapshot module 260. For example, in some embodiments, the compute instance sorting module 240 is configured to sort compute instances by total CPU capacity from largest to smallest. In some embodiments, the compute instance sorting module 240 is configured to sort compute instances by total memory capacity from largest to smallest. In some embodiments, the compute instance sorting module 240 is configured to sort compute instances by the CPU-to-memory capacity ratio from smallest to largest.

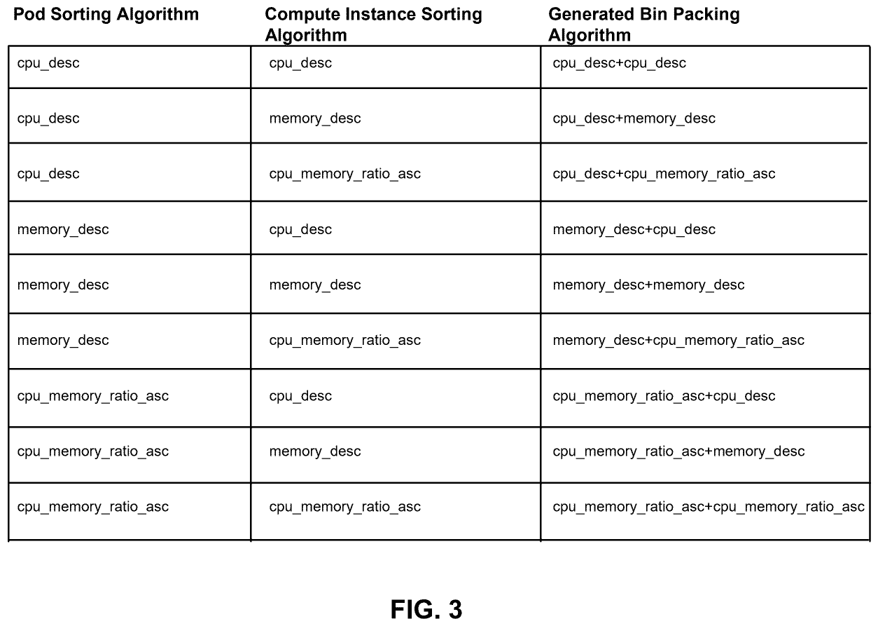

The pod placing module 250 can then generate algorithms based on the sorted order of the pods and the sorted order of the compute instances. FIG. 3 is a table 300 showing different bin packing algorithms generated by combining pod sorting algorithms and compute instance sorting algorithms. The first row of the table shows a bin packing algorithm based on sorting pods from highest to lowest CPU request and compute instances from highest to lowest CPU capacity. This ensures that the most CPU-demanding pods are placed in the largest CPU-capable instances first, maximizing resource utilization and preventing CPU fragmentation across smaller nodes. The second row of the table shows a bin packing algorithm based on sorting pods based on CPU requests and sorting compute instance by memory capacity. This approach is beneficial for scenarios where workloads are CPU-intensive but need to be placed in memory-rich instances, potentially balancing workloads across instances with different resource profiles. Similarly, each row in the table represents a bin packing algorithm based on different sorting algorithms for pods and compute instances.

For example, as shown in Tables 7-8 below, pods P1 (requesting 8 cores), P2 (requesting 6 cores), and P3 (requesting 4 cores) are sorted based on CPU requests from largest to smallest, and compute instances C1 (with 16 cores), C2 (with 8 cores), and C3 (with 4 cores) are sorted based on total CPU capacity from largest to smallest.

TABLE 7

| Pods | CPU Request |
|---|---|
| P1 | 8 Cores |
| P2 | 6 Cores |
| P3 | 4 Cores |

TABLE 8

| Compute Instances | CPU Capacity |
|---|---|
| C1 | 16 Cores |
| C2 | 8 Cores |
| C3 | 4 Cores |

The pod placing module 250 places the largest pod (P1) in the largest compute instance (C1), i.e., P1 (requesting 8 cores) is placed in C1 (with 16 cores), resulting in C1 having 8 cores remaining. After that, the pod placing module 250 determines whether the second-largest pod (P2) can also be placed in the largest compute instance (C1). If the largest compute instance (C1) does not have sufficient capacity, the second-largest compute instance (C2) will then be considered. Here, the largest compute instance (C1) has 8 cores remaining, and the second-largest pod (P2) requests 6 cores. Thus, C1 has sufficient capacity to accommodate P2, and P2 is placed in C1, resulting in C1 having 2 cores remaining. Next, the pod placing module 250 determines whether the next-largest pod (P3) can also be placed in the largest compute instance (C1). However, C1 only has 2 cores remaining, while P3 requests 4 cores. Thus, C1 does not have sufficient capacity to accommodate P3. Compute instance C2, which has 8 cores, is considered, and P3 is placed in C2, resulting in C2 having 4 cores remaining. Thus, the final placement result is that P1 and P2 are placed in C1, P3 is placed in C2, and C3 remains unused. This placement is shown in Table 9 below.

TABLE 9

| Compute Instances | Allocated Pods | Remaining CPU |
|---|---|---|
| C1 (16 Cores) | P1 (8 Cores), P2 (6 Cores) | 2 Cores |
| C2 (8 Cores) | P3 (4 Cores) | 4 Cores |
| C3 (4 Cores) | Unused | 4 Cores |

The analysis module 270 is configured to use the snapshots collected by the snapshot module 260 as an input to determine performance metrics of each bin packing algorithm, and identify a best bin packing algorithm based on the performance metrics. In some embodiments, the analysis module 270 runs alternative bin packing algorithms on the snapshots in parallel as shadow processes. These background executions do not affect live pod scheduling but instead simulate pod placements based on real-time workload data. In some embodiments, the analysis module 270 captures incoming pod scheduling events and replicates these events across different placement algorithms in a background simulation environment. Each algorithm processes the same workload snapshot, allowing the analysis module 270 to collect performance metrics of different bin packing algorithms.

For example, in some embodiments, for each bin packing algorithm, the analysis module 270 may collect and record resource utilization metrics, including (but not limited to) CPU utilization (which measures how much of the available CPU cores are being used across compute instances), memory utilization, GPU utilization, node fragmentation (which measures how much unused CPU and/or memory is left in each node after pod placements). Alternatively or in addition, in some embodiments, for each bin packing algorithm, the analysis module 270 may collect and record metrics about how fast and efficiently different algorithms place pods on nodes, including (but not limited to) scheduling latency (which indicates time taken for a pod to be assigned to a node), bin packing execution time (which indicates how long a specific bin packing algorithm takes to compute placements), and/or number of pods scheduled per minutes (which indicates how quickly the system can process incoming pod placement requests. Alternatively, or in addition, in some embodiments, for each bin packing algorithm, the analysis module 270 may collect cost metrics, including (but not limited to) total compute cost, savings compared to default algorithm, and/or price per scheduled pod. Alternatively, or in addition, in some embodiments, for each bin packing algorithm, the analysis module 270 may collect autoscaler behavior data, including (but not limited to) a number of scale-ups per hour, a number of scale-downs per hour, and/or time to scale up.

In some embodiments, the analysis module 270 may compute statistical values, such as mean, median, minimum and maximum values for the collected performance metric values. An overall performance score may then be computed based on these statistical values. For example, below equation may be used to compute an overall performance score for each bin packing algorithm:

$$Score = w 1 \times Mean + w 2 \times Median + w 3 \times Min ,$$

where Mean represents a mean value of a performance metric, Median represents a median value of the performance metric, Min represents a minimum value of the performance metric, and w1, w2, and w3 are configurable weight parameters that determine the contribution of the Mean, Median, and Min values to the final score.

Depending on the performance metrics, lower or higher scores may be better. For example, if the performance metric is associated with a cost of compute resource, the lower scores are better.

In some embodiments, machine learning algorithms may be implemented to determine an overall performance score. The machine learning model can analyze historical performance data, identify patterns in resource utilization, and predict which algorithms will perform best under different workload conditions. A supervised learning model, such as a regression algorithm, can be trained using past performance metrics (e.g., CPU utilization, scheduling latency, node fragmentation, and cost efficiency) to predict the expected performance score of a given bin packing algorithm. Alternatively, reinforcement learning techniques can be applied where the analysis module 270 continuously explores different placement strategies and updates performance scores based on real-world results. Deep learning models, such as neural networks, can further enhance scoring by detecting complex relationships between placement algorithms and their long-term effects on autoscaling and resource allocation.

The autoscaler module 270 is configured to dynamically place pod onto existing compute instances and/or adjust the number of compute instances based on a pod placement algorithm in response to workload demands. The autoscaler module 270 continuously monitors pod scheduling events, resource utilization, and system constraints to determine whether additional nodes should be added (scale-up) or underutilized nodes should be removed (scale-down). When a pod cannot be scheduled due to insufficient resources, the autoscaler module 270 triggers a scale-up event, provisioning new compute instances to accommodate the workload. Conversely, if existing nodes are underutilized, the autoscaler may trigger a scale-down event, deallocating excess instances to optimize efficiency. The autoscaler module 270 interacts closely with the node placer module 220, using bin packing algorithms and performance data to ensure that newly provisioned nodes are efficiently utilized.

For example, when a new pod is to be scheduled, the autoscaler module 270 may evaluate whether the pod can fit into an existing node using the implemented bin packing algorithm before considering scaling up. In some embodiments, the autoscaler module 270 may attempt to place the new pod in an existing node based on the bin packing algorithm without modifying the current placements of other pods. In response to determining that no compute instance is available, the autoscaler module 270 may rerun the bin packing algorithm on all pods (including the new pod) and all compute instances to determine whether all pods can be placed on the existing compute instances. If the implemented bin packing algorithm is based on pod CPU request order and compute instance CPU capacity order, the autoscaler module 270 traverses compute instances in descending order of CPU capacity to select the first available compute instance for pod placement.

If no existing compute instance can accommodate all the pods (including the new pod), the autoscaler module 270 provisions a new compute instance. After provisioning the new compute instance, the autoscaler module 270 may either rerun the grouping algorithm and/or bin packing algorithm to reschedule all pods or simply place the new pod on the newly provisioned node.

### Example Code Snippets

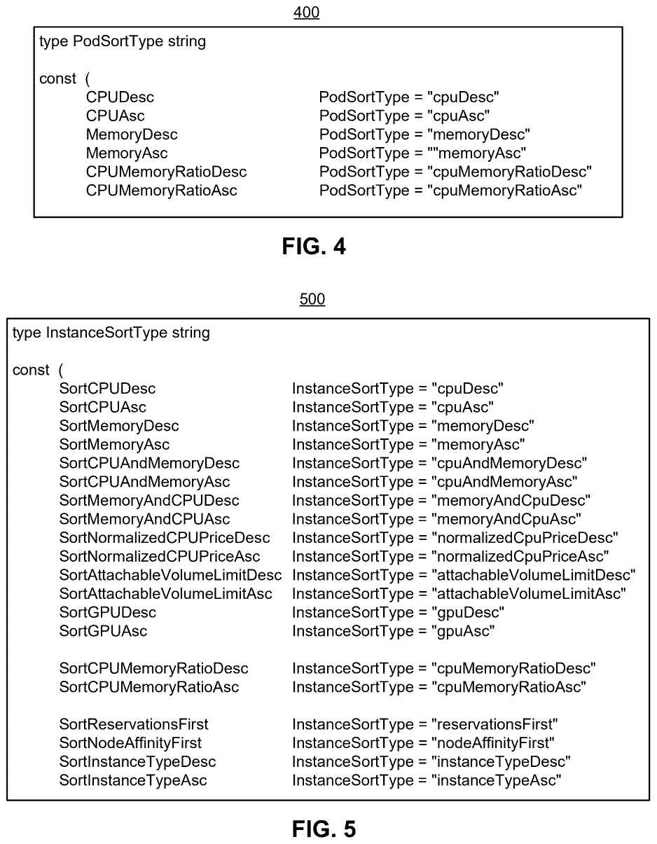

FIGS. 4-7 illustrate example code snippets that organize algorithms and data structures, which may be implemented to achieve the node placement and scheduling optimization described herein. Additional or alternative code may be used to implement the same or similar embodiments. The snippets are written in the Go language; however, a person skilled in the art would understand that other programming languages may also be used to implement these embodiments. These code snippets are merely examples.

FIG. 4 illustrates an example code snippet 400 that defines a list of pod sorting algorithms that represent different ways to sort pods, in accordance with one or more embodiments. CPUDesc represents sorting pods by CPU request (largest to smallest); CPUAsc represents sorting pods by CPU request (smallest to largest); MemoryDesc represents sorting pods by memory request (largest to smallest); MemoryAsc represents sorting pods by memory request (smallest to largest); CPUMemoryRatioDesc represents sorting pods by CPU-to-memory ratio (largest to smallest); and CPUMemoryRatioAsc represents sorting pods by CPU-to-memory ratio (smallest to largest).

FIG. 5 illustrates an example code snippet 500 that defines a list of compute instance sorting algorithms that represents different ways to sort compute instances, in accordance with one or more embodiments. SortMemoryAsc represents sorting compute instances by memory capacity (smallest to largest); SortCPUAndMemoryDesc represents sorting compute instances by the combined CPU and memory capacity (largest to smallest); SortCPUAndMemoryAsc represents sorting compute instances by the combined CPU and memory capacity (smallest to largest); SortMemoryAndCPUDesc represents sorting compute instances by memory capacity first, then CPU capacity (largest to smallest); SortMemoryAndCPUAsc represents sorting compute instances by memory capacity first, then CPU capacity (smallest to largest); SortNormalizedCPUPriceDesc represents sorting compute instances by normalized CPU cost per core (highest to lowest); SortNormalizedCPUPriceAsc represents sorting compute instances by normalized CPU cost per core (lowest to highest, prioritizing cost-efficient instances); SortAttachable VolumeLimitDesc represents sorting compute instances by the maximum number of attachable storage volumes (largest to smallest); SortAttachable VolumeLimitAsc represents sorting compute instances by the minimum number of attachable storage volumes (smallest to largest); SortGPUDesc represents sorting compute instances by GPU capacity (largest to smallest); SortGPUAsc represents sorting compute instances by GPU capacity (smallest to largest); SortCPUMemoryRatioDesc represents sorting compute instances by CPU-to-memory ratio (largest to smallest); SortCPUMemoryRatioAsc represents sorting compute instances by CPU-to-memory ratio (smallest to largest, prioritizing memory-heavy instances); SortReservationsFirst represents prioritizing reserved instances before other instance types; SortNode AffinityFirst represents prioritizing instances based on node affinity rules; SortInstance TypeDesc represents sorting compute instances by instance type in descending order; and SortInstanceTypeAsc represents sorting compute instances by instance type in ascending order.

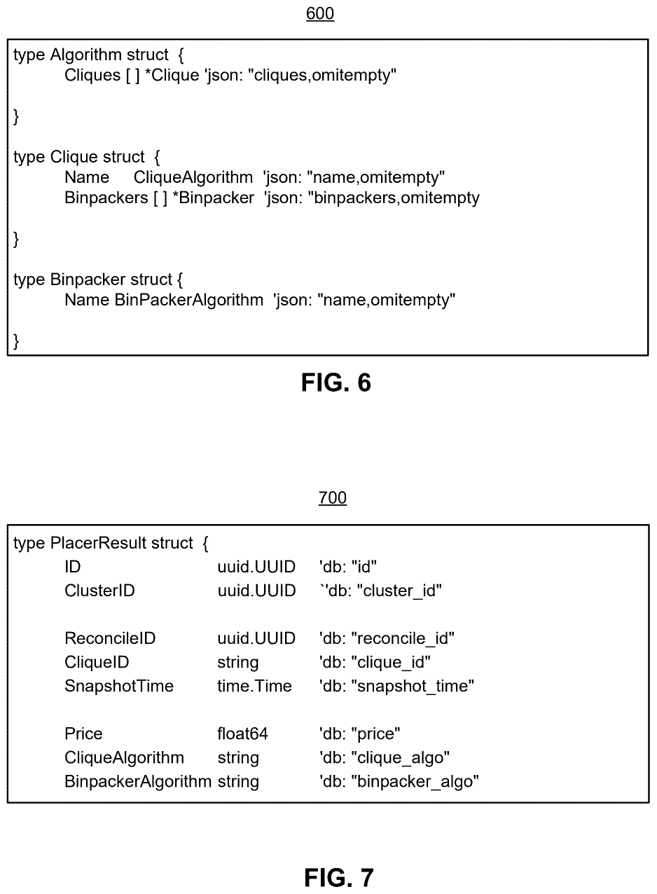

FIG. 6 illustrates an example code snippet 600 that defines a hierarchical structure for managing bin packing algorithms and grouping algorithms, in accordance with one or more embodiments. In particular, the code snippet 600 includes three struct types in three different levels, Algorithm, Clique, and Blinpacker.

At the lowest level, the Binpacker struct represents an individual bin packing algorithm. Each bin packing algorithm defines a specific algorithm for assigning workloads (pods) to compute instances. The Clique struct is at the middle level, representing a pod grouping algorithm that defines how workloads are grouped before bin packing algorithms are applied. Each Clique struct maintains an array of Binpacker structs, indicating multiple corresponding bin packing algorithms are applied to a given grouping algorithm. At the top level, the Algorithm struct defines the iteration over multiple Clique structs. The Algorithm struct enables the application of different pod grouping algorithms, each of which, in turn, triggers application of different bin packing algorithms, and evaluates the effectiveness of each grouping algorithm and bin packing algorithm.

Based on the hierarchical structure, the pod grouping algorithm may be periodically performed at a first frequency, and the bin packing algorithms may be periodically performed at a second frequency. In some embodiments, the second frequency is greater than the first frequency, which is advantageous because workload placement constraints do not change as frequently; therefore, the system does not need to recompute pod groupings as often.

FIG. 7 illustrates an example code snippet 700 configured to capture results of pod placement operations, in accordance with one or more embodiments. In particular, the code snippet 700 includes a data structure, referred to as PlacerResult struct for capturing the results of pod placement operations. The PlacerResult struct includes multiple fields, each of which holds information about a specific attribute of a pod placement decision. The fields of the PlacerResult struct includes an ID field corresponding to each pod placement record, configured to distinguish individual placement execution. A clusterID field represents a cluster in which the pod placement decision was executed. A reconcileID field represents a specific scheduling reconciliation process, which may involve reassigning or adjusting pod placements based on dynamic workload conditions. A CliqueID field represents the pod grouping strategy applied in the placement decision. A SnapshotTime field represents a timestamp, allowing for historical tracking of scheduling performance trends. A Price field represents a computed cost associated with the placement decision. A CliqueAlgorithm field represents a specific pod grouping algorithm applied in the execution. A BinpackerAlgorithm field represents a bin packing algorithm applied in the execution. The PlacerResult struct allows performance evaluation of various scheduling strategies. By recording the clique algorithm, bin packing algorithm, and associated placement cost, the system can determine which combinations yield the most efficient and cost-effective resource allocations.

### Example Methods for Pod Placement

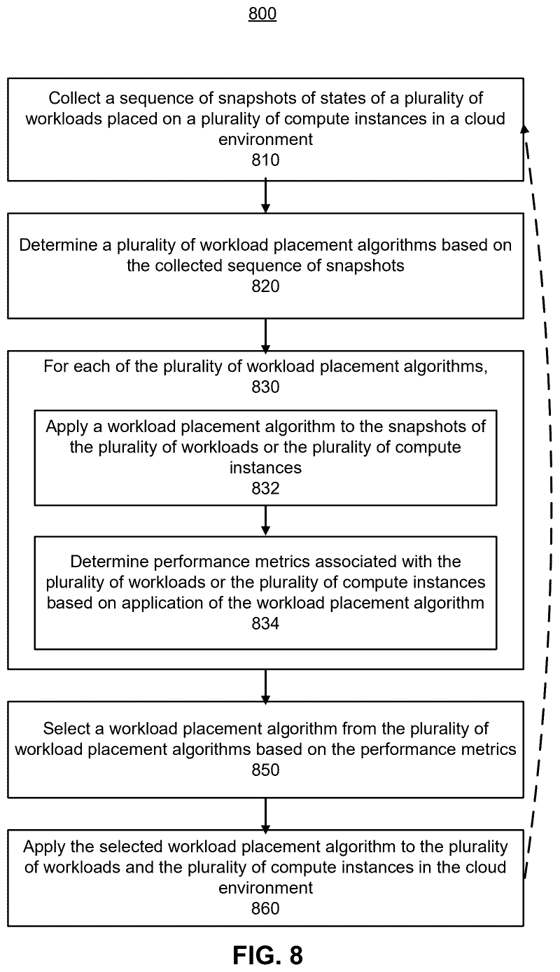

FIG. 8 is a flowchart of a method 800 for pod placement in a cloud computing environment, in accordance with one or more embodiments. In various embodiments, the method includes different or additional steps than those described in conjunction with FIG. 8. Further, in some embodiments, the steps of the method may be performed in different orders than the order described in conjunction with FIG. 8. The method described in conjunction with FIG. 8 may be carried out by the automation system 110 in various embodiments, while in other embodiments, the steps of the method are performed by any online system capable of performing these steps.

The automation system 110 collects 810 a sequence of snapshots of states of a plurality of workloads placed on a plurality of compute instances in a cloud environment. The step 810 may be performed by the snapshot module 260 described above with respect to FIG. 2. The plurality of workloads may initially be placed on the plurality of compute instances based on a static algorithm. Alternatively, the plurality of workloads may be placed on the plurality of compute instances based on a previously selected bin packing algorithm. In some embodiments, the snapshots may be collected based on various Kubernetes APIs, cloud service provider APIs, and/or autoscaler. In some embodiments, the automation system 110 queries these APIs periodically, such as every 15 seconds, to obtain real time states of the workloads and compute instances. In some embodiments, the snapshots may include a resource utilization snapshot indicating CPU or memory usage of each compute instance, a network traffic snapshot indicating communicating patterns between workloads, and/or a scheduling snapshot indicating scheduling latency, e.g., how long it takes for an autoscale schedules a workload onto a compute instance.

The automation system 110 determines 820 a plurality of workload placement algorithms based on the collected sequence of snapshots. The workload placement algorithms may be bin packing algorithms, where the compute instances correspond to bins, and workloads correspond to items that are to be packed into the bins. Each of the workload placement algorithm, when applied, places each workload into a compute instance. In some embodiments, the step 820 may be performed by the bin packing module 220 described above with respect to FIG. 2.

In some embodiments, each of the workload placement algorithm is based on a first sorting criterion for the plurality of workloads and a second sorting criterion for the plurality of compute instances. In some embodiments, application of the first sorting criterion includes sorting workloads based on one or more of: CPU requests, memory requests, CPU-to-memory ratio, and/or network bandwidth requirement. In some embodiments, application of the second sorting criterion includes sorting workloads based on one or more of: CPU capacity, memory capacity, GPU capacity, or attachable volume limits.

For each of the plurality of workload placement algorithms 830, the automation system 110 applies 832 a workload placement algorithm to the snapshots of the plurality of workloads, and determines 834 performance metrics associated with the plurality of workloads or the plurality of compute instances based on application of the workload placement algorithm. In some embodiments, applying a workload placement algorithm includes sorting the plurality of workloads in a first order based on the first sorting criterion, sorting the plurality of compute instances in a second order based on the second sorting criterion, and sequentially placing each workload in a compute instance base on the first order of the plurality of workloads and the second order of the plurality of compute instances. In some embodiments, the step 832 and the step 834 may be performed by the analysis module 270 described above with respect to FIG. 2.

In some embodiments, the plurality of workloads are first grouped into groups based on whether each of the plurality of workloads is compatible with each of the plurality of compute instances. In some embodiments, the grouping is based on a least groups grouping algorithm, where a grouping containing a least number of groups is selected. Alternatively, or in addition, the grouping is further based on an AZ constraints grouping algorithms, where AZ constraints are also applied to the grouping decisions. A plurality of workload placement is determined and applied for each group of workloads. In some embodiments, grouping of the workloads is performed by the grouping module 210 described above with respect to FIG. 2.

The automation system 110 selects 850 a workload placement algorithm from the plurality of workload placement algorithms based on the performance metrics. In some embodiments, selecting the workload placement algorithm includes determining a performance score, for each work placement algorithm, based on a weighted combination of mean, median, and minimum performance metric (e.g., cost), and selects the workload placement algorithm with a highest performance score. Alternatively, or in addition, the selection of the workload placement algorithm is based on a machine learning model trained on historical placement performance data. The machine learning model is trained to determine a performance score of each workload placement algorithm and selects the workload placement algorithm with a highest performance score. In some embodiments, the step 850 may be performed by the analysis module 270 described above with respect to FIG. 2

The automation system 110 applies 860 the selected workload placement algorithm to the plurality of workloads and the plurality of compute instances in the cloud environment. The application of the selected workload placement algorithm causes at least one workload to be moved from its current compute instance to a different compute instance in the cloud environment. In some embodiments, applying the workload placement algorithm includes sorting the plurality of workloads in a first order based on the first sorting criterion, sorting the plurality of compute instances in a second order based on the second sorting criterion, and sequentially placing each workload in a compute instance based on the first order of the plurality of workloads and the second order of the plurality of compute instances. In some embodiments, in response to identifying a new workload that needs to be placed onto a compute instance, the automation system 110 selects a compute instance from the plurality of compute instances based on the selected workload placement algorithm. In some embodiments, the step 850 may be performed by the autoscaler module 280 described above with respect to FIG. 2.

The process of bin packing or pod placements described above can be performed periodically to ensure optimal workload distribution across compute instances. Additionally, the system also performs grouping determinations periodically to identify the most efficient pod placements before applying bin packing algorithms. In some embodiments, the frequency of these operations may vary, as different processes require different levels of computational overhead and responsiveness. Snapshots of workload states and compute instances are collected most frequently, providing real-time data on resource utilization, workload distribution, and cluster conditions. Bin packing determinations are performed less frequently than snapshot collection, ensuring that workload placement decisions are made based on updated but stable resource data. Grouping determinations may occur even less frequently than bin packing, as grouping strategies tend to remain effective for extended periods and larger-scale evaluations. This hierarchical approach balances accuracy and efficiency, ensuring that placement algorithms are applied dynamically while minimizing unnecessary computation and system overhead.

### Example Computing System

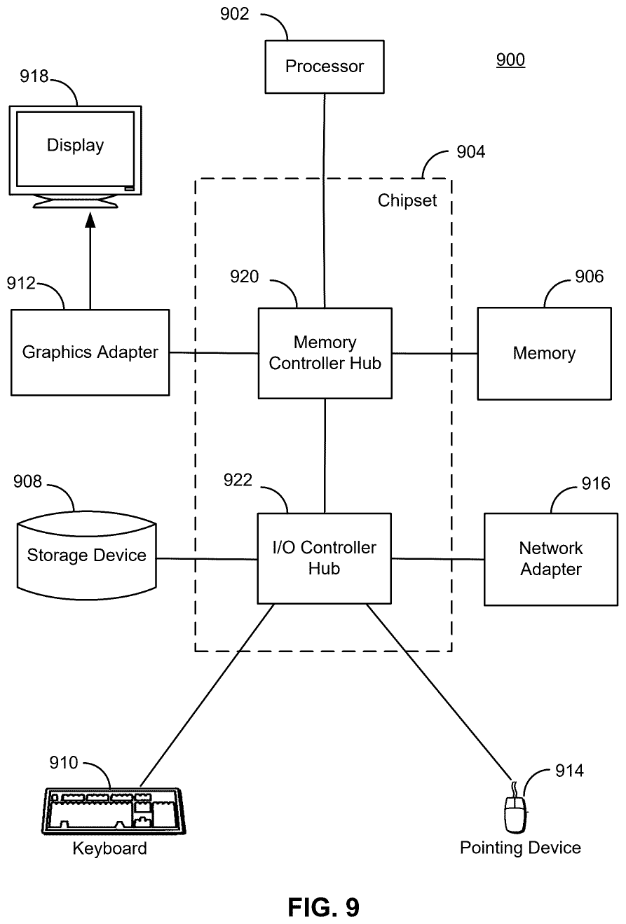

FIG. 9 is a block diagram of an example computer 900 suitable for use in the networked computing environment 100 of FIG. 1. The computer 900 is a computer system and is configured to perform specific functions as described herein. For example, the specific functions corresponding to automation system 110 may be configured through the computer 900.

The example computer 900 includes a processor system having one or more processors 902 coupled to a chipset 904. The chipset 904 includes a memory controller hub 920 and an input/output (I/O) controller hub 922. A memory system having one or more memories 906 and a graphics adapter 912 are coupled to the memory controller hub 920, and a display 918 is coupled to the graphics adapter 912. A storage device 908, keyboard 910, pointing device 914, and network adapter 916 are coupled to the I/O controller hub 922. Other embodiments of the computer 900 have different architectures.

In the embodiment shown in FIG. 9, the storage device 908 is a non-transitory computer-readable storage medium such as a hard drive, compact disk read-only memory (CD-ROM), DVD, or a solid-state memory device. The memory 906 holds instructions and data used by the processor 902. The pointing device 914 is a mouse, track ball, touchscreen, or other types of a pointing device and may be used in combination with the keyboard 910 (which may be an on-screen keyboard) to input data into the computer 900. The graphics adapter 912 displays images and other information on the display 918. The network adapter 916 couples the computer 900 to one or more computer networks, such as network 150.

The types of computers used by the entities and the automation system 110 of FIGS. 1 through 8 can vary depending upon the embodiment and the processing power required by the enterprise. For example, the automation system 110 might include multiple blade servers working together to provide the functionality described. Furthermore, the computers can lack some of the components described above, such as keyboards 910, graphics adapters 912, and displays 918.

### Additional Considerations

The disclosed embodiments provide technical effects that enhance workload placement efficiency, resource utilization, and autoscaling performance in a cloud computing environment. By periodically collecting snapshots of workload states and compute instance availability, the system ensures that placement decisions are based on real-time data rather than static heuristics. The dynamic determination of grouping and bin packing algorithms enables the system to adapt to changing workload patterns and infrastructure constraints, improving cluster efficiency while minimizing computational overhead. Furthermore, the hierarchical approach to snapshot collection, grouping, and bin packing determination ensures that the system prioritizes responsiveness without excessive processing resource consumption. By selecting the best-performing workload placement algorithm based on empirical performance metrics, the invention optimizes compute resource allocation, reduces node fragmentation, and lowers resource consumption. Additionally, by automating and continuously refining workload placement strategies, the system reduces manual intervention, leading to more scalable, reliable, and cost-effective cloud operations.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcodes, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
collecting a sequence of snapshots of states of a plurality of workloads placed on a plurality of compute instances in a cloud environment;
determining a plurality of workload placement algorithms based on the collected sequence of snapshots, wherein each of the plurality of workload placement algorithms, when applied, places each workload into a compute instance based on applying a first sorting criterion for the plurality of workloads and a second sorting criterion for the plurality of compute instances;
for each of the plurality of workload placement algorithms,
applying a workload placement algorithm to the sequence of snapshots of the plurality of workloads; and
determining performance metrics associated with the plurality of workloads or the plurality of compute instances based on application of the workload placement algorithm;
selecting a workload placement algorithm from the plurality of workload placement algorithms based on the performance metrics; and
applying the selected workload placement algorithm to the plurality of workloads and the plurality of compute instances in the cloud environment, causing at least one workload to be moved from a first compute instance to a second compute instance in the cloud environment.

2. The method of claim 1, further comprising periodically repeating steps of:
determining a plurality of workload placement algorithms based on a recently collected sequence of snapshots;
applying the plurality of workload placement algorithms based on the collected sequence of snapshots;
for each of the plurality of workload placement algorithms, determining performance metrics associated with the plurality of workloads or the plurality of compute instances;
selecting a workload placement algorithm from the plurality of workload placement algorithms based on the performance metrics; and
applying the selected workload placement algorithm to the plurality of workloads and the plurality of compute instances in the cloud environment.

3. The method of claim 2, wherein each snapshot is collected at a first frequency, and
wherein determination of a plurality of workload placement algorithms based on recently collected sequence of snapshots is performed at a second frequency lower than the first frequency.

4. The method of claim 1, wherein the sequence of snapshots of states of the plurality of workloads placed on the plurality of compute instances include at least one of:
a resource utilization snapshot indicating CPU or memory usage of each compute instance;
a network traffic snapshot indicating communication patterns between workloads; or
a scheduling snapshot indicating scheduling latency.

5. The method of claim 1, further comprising grouping the plurality of workloads into groups based on whether each of the plurality of workloads is compatible with each of the plurality of compute instances, wherein a plurality of workload placement algorithms is determined for each group of workloads.

6. The method of claim 3, wherein grouping of the plurality of workloads is based on one or more of: (1) minimizing a number of compute instances, and (2) separating workloads based on availability zone constraints.

7. The method of claim 1, wherein applying the first sorting criterion includes sorting workloads based on one or more of: CPU requests, memory requests, CPU-to-memory ratio, or network bandwidth requirement.

8. The method of claim 1, wherein applying the second sorting criterion includes sorting workloads based on one or more of: CPU capacity, memory capacity, GPU capacity, or attachable volume limits.

9. The method of claim 1, wherein applying a workload placement algorithm includes:
sorting the plurality of workloads in a first order based on the first sorting criterion;
sorting the plurality of compute instances in a second order based on the second sorting criterion; and
sequentially placing each workload in a compute instance based on the first order of the plurality of workloads and the second order of the plurality of compute instances.

10. The method of claim 1, wherein selecting the workload placement algorithm includes:
applying a machine learning model trained on historical placement performance data to each workload placement algorithm to determine a performance score of a corresponding workload placement algorithm; and
selecting the workload placement algorithm with a highest performance score.

11. The method of claim 4, wherein selecting a workload placement algorithm includes:
determining, for each work placement algorithm, a performance score based on a weighted combination of mean, median, and minimum performance metric over a predefined time period; and
selecting the workload placement algorithm with a highest performance score.

12. The method of claim 1, wherein applying the selected workload placement algorithm to the plurality of workloads in the cloud environment includes:
in response to identifying a new workload that needs to be placed onto a compute instance, selecting a compute instance from the plurality of compute instances based on the selected workload placement algorithm.

13. A non-transitory computer readable storage medium having instructions encoded thereon that, when executed by one or more processors, cause the one or more processors to perform steps comprising:
collecting a sequence of snapshots of states of a plurality of workloads placed on a plurality of compute instances in a cloud environment;
determining a plurality of workload placement algorithms based on the collected sequence of snapshots, wherein each of the plurality of workload placement algorithms, when applied, places each workload into a compute instance based on applying a first sorting criterion for the plurality of workloads and a second sorting criterion for the plurality of compute instances;
for each of the plurality of workload placement algorithms,
applying a workload placement algorithm to the sequence of snapshots of the plurality of workloads; and
determining performance metrics associated with the plurality of workloads or the plurality of compute instances based on application of the workload placement algorithm;
selecting a workload placement algorithm from the plurality of workload placement algorithms based on the performance metrics; and
applying the selected workload placement algorithm to the plurality of workloads and the plurality of compute instances in the cloud environment, causing at least one workload to be moved from a first compute instance to a second compute instance in the cloud environment.

14. The non-transitory computer readable storage medium of claim 13, wherein following steps are periodically repeated:
determining a plurality of workload placement algorithms based on a recently collected sequence of snapshots;
applying the plurality of workload placement algorithms based on the collected sequence of snapshots;
for each of the plurality of workload placement algorithms, determining performance metrics associated with the plurality of workloads or the plurality of compute instances;
selecting a workload placement algorithm from the plurality of workload placement algorithms based on the performance metrics; and
applying the selected workload placement algorithm to the plurality of workloads and the plurality of compute instances in the cloud environment.

15. The non-transitory computer readable storage medium of claim 14, wherein each snapshot is collected at a first frequency, and
wherein determination of a plurality of workload placement algorithms based on recently collected sequence of snapshots is performed at a second frequency lower than the first frequency.

16. The non-transitory computer readable storage medium of claim 13, wherein the snapshots of state of the plurality of workloads placed on the plurality of compute instances include at least one of:
a resource utilization snapshot indicating CPU or memory usage of each compute instance;
a network traffic snapshot indicating communication patterns between workloads; or
a scheduling snapshot indicating scheduling latency.

17. The non-transitory computer readable storage medium of claim 13, the steps further comprising grouping the plurality of workloads into groups based on whether each of the plurality of workloads is compatible with each of the plurality of compute instances, wherein a plurality of workload placement algorithms is determined for each group of workloads.

18. The non-transitory computer readable storage medium of claim 16, wherein grouping of the plurality of workloads is based on one or more of: (1) minimizing a number of compute instances, and (2) separating workloads based on availability zone constraints.

19. The non-transitory computer readable storage medium of claim 13, applying the first sorting criterion includes sorting workloads based on one or more of: CPU requests, memory requests, CPU-to-memory ratio, or network bandwidth requirement.

20. A system, comprising:
one or more processors; and
a non-transitory computer readable storage medium having instructions encoded thereon that, when executed by the one or more processors, cause the one or more processors to perform steps comprising:
collecting a sequence of snapshots of states of a plurality of workloads placed on a plurality of compute instances in a cloud environment;
determining a plurality of workload placement algorithms based on the collected sequence of snapshots, wherein each of the plurality of workload placement algorithms, when applied, places each workload into a compute instance based on applying a first sorting criterion for the plurality of workloads and a second sorting criterion for the plurality of compute instances;
for each of the plurality of workload placement algorithms,
applying a workload placement algorithm to the sequence of snapshots of the plurality of workloads; and
determining performance metrics associated with the plurality of workloads or the plurality of compute instances based on application of the workload placement algorithm;
selecting a workload placement algorithm from the plurality of workload placement algorithms based on the performance metrics; and
applying the selected workload placement algorithm to the plurality of workloads and the plurality of compute instances in the cloud environment, causing at least one workload to be moved from a first compute instance to a second compute instance in the cloud environment.
